(19) United States
(12) Patent Application Publication
(10) Pub. No.: US 2008/0140509 A1
(43) Pub. Date: Jun. 12, 2008

(54) SYSTEM AND METHOD FOR PROVIDING SECURE ELECTRONIC COUPONS TO WIRELESS ACCESS POINT USERS

(76) Inventor: Kamran Amjadi, Bethesda, MD (US)

Correspondence Address: PILLSBURY WINTHROP SHAW PITTMAN, LLP, P.O. BOX 10500, MCLEAN, VA, 22102, US

(21) Appl. No.: 11/853,430

(22) Filed: Sep. 11, 2007

Related U.S. Application Data
(60) Provisional application No. 60/843,399, filed on Sep. 11, 2006.

(51) Int. Cl. G06Q 30/00

(52) U.S. Cl. 705/10; 705/14

(57) ABSTRACT

A system and method may provide secure electronic incentives to users of a wireless access point (WAP). Retailers, merchants, or other marketers of goods or services may submit incentives, such as coupons or promotions, to a server. The server may categorize and catalog the incentives based on various characteristics of the distributing entity. When a user accesses the Internet through a WAP, the server may identify at least the geographical location of the WAP. User characteristics may also be identified, such as demographics or purchasing habits of the user. The server may deliver targeted incentives to users of the WAP based on the identified characteristics. The incentives may be redeemed and the way in which incentives are targeted may be refined based on the characteristics of the redemption.

### CROSS REFERENCE TO RELATED APPLICATIONS

This application claims the benefit of U.S. Provisional Patent Application Ser. No. 60/843,399, entitled “System and Method Providing Secure Electronic Coupons to Wireless Access Point Users,” filed Sep. 11, 2006, the disclosure of which is hereby incorporated by reference in its entirety.

### FIELD OF THE INVENTION

The invention relates generally to distributing secure electronic incentives, such as money-saving discount coupons or other marketing incentives, and more particularly, to customizing incentives for a user based on a wireless access point associated with the user.

### BACKGROUND OF THE INVENTION

In response to the rise of e-commerce, retailers and other enterprises are continually searching for innovative and creative ways to reach consumers. One way in which retailers have exploited the demand created by the development of information technology and e-commerce is by responding to the needs of a particular clientele. For example, some retailers have attempted to attract mobile computer users to their storefronts by providing Internet access through a wireless access point (WAP) referred to as a “hotspot.” However, providing WiFi access tends to include significant overhead, such as deployment, maintenance, billing, and technical support, the costs of which is passed along to consumers in the form of subscription fees or access charges. In some instances, these costs may discourage customers from paying for a service that they only use sporadically.

Existing approaches for closing the gap between what a consumer is willing to pay for WiFi access and what a WiFi operator charges have generally focused on providing advertisements to a consumer. However, advertisements, pop-ups, and other such marketing campaigns may be bothersome to some Internet users. Additionally, WAP providers are generally unable to exploit the hotspot to drive sales, instead having to rely on consumers independently making purchases while present in their storefront.

### SUMMARY OF THE INVENTION

According to various aspects of the invention, a system and method for generating and distributing customized product redemption incentives to users based on a wireless access point (WAP) may address these and other drawbacks of existing systems.

According to various aspects of the invention, the system for generating and distributing customized product redemption incentives to users based on a wireless access point (WAP) may comprise a repository, such as a database, which stores electronic incentive data. The repository may be associated with a server, and a marketing/targeting module may also be associated with the server. The marketing/targeting module may correlate incentive data with user demographic data and/or WAP demographic data to deliver customized incentive packages to users (see, for example, U.S. Patent Application Pub. No. 2005/0209921, entitled “Proximity-Based Method and System for Generating Customized Incentives,” filed Sep. 10, 2004, the disclosure of which is hereby incorporated by reference in its entirety). In various implementations, a user may connect to a WAP to access a network (e.g., the Internet). The network connection may be configured to route through a proxy, thereby enabling monitoring of user activity to deliver more relevant incentives, and facilitating electronic transactions. In various implementations, the WAP may be configured to route traffic through the proxy, and the user may download a client application to establish the connection with the proxy, or the user may connect directly to the server.

The repository may store electronic incentives in a database. As used herein, an “incentive” may broadly include, without limitation, a web page, promotion, banner, coupon, gift offer, raffle, contest ticket, giveaway, discounted product price, discount applicable to a product purchase or future product purchases, a link to an incentive, or any combination thereof. As used herein, “incentive data” may broadly refer to data that describes an incentive, including generic incentive data such as a product, a redemption amount, an expiration date, or terms and conditions, as well as customized incentive data such as a user proximity to a point-of-sale, a retail center, or a site of an event, without limitation. The electronic incentives may be provided by a retailer, coupon issuer, or other entity, and the electronic incentives may be associated with incentive data. Incentives may be customized based on proximity by varying a discount amount based on a user's distance from a point-of-sale, the user's purchasing characteristics, or on other characteristics.

According to various implementations of the invention, an online display may present a user with an interface for downloading incentives containing secure incentive data. For example, a visual or auditory stimulus may be provided to a user, suggesting accessibility of the electronic incentive distribution system. An incentive may be secured by using a secure data format to encode the incentive, such as providing a unique bar code for a user, encoding the incentive to only allow the incentive to be printed a predetermined number of times, encrypting the incentive when delivering the inventive to a user, or using other techniques of securing data.

The repository may also store demographic data in a database, including user demographic data and/or WAP demographic data, to be used in generating customized incentive packages for a user. User demographic data may include user-specific data such as age or gender, as well as derived data such as purchasing habits identified by analyzing incentives the user has selected, deleted, redeemed, etc. Each user may be assigned a unique identifier, or the user may be prompted to select a unique identifier. The unique identifier may comprise a unique user identifier that identifies the user, or a device identifier that identifies a device which the user utilizes to access the system. The unique identifier may be used to associate a user with their demographic information. Demographic information may be obtained by the user entering demographic information into an online application, downloading an offline management program to enter the data later, or through other techniques. WAP demographic data may include a geographical location of the WAP or a type of operation of the WAP provider. The WAP may be uniquely identified using an IP address, a unique identifier, or other identification techniques. The database may also include information corresponding to the location of retailers and/or retail centers where incentives may be redeemed. Information regarding the location of retailers and/or retail centers may be provided by the retailer or retail center, by a coupon issuing entity, by looking up a location of a retailer and/or retail center in a directory, or by any other means.

The repository may utilize the demographic data to compile incentive packages specifically targeted at users based on various criteria, including their location within a geographic area, proximity to a retail center, or likelihood of purchasing a particular product. Incentives may also be targeted to users based on characteristics or patterns of user activity at a particular WAP or type of WAP. Depending on marketing and targeting criteria and objectives, incentives may be identified or promotions customized based on any combination of user or WAP demographic data, proximity ranges or geographic information, competitor parameters, or other marketing and targeting criteria or objectives.

Data concerning redemption of incentives may be used in updating user and/or WAP demographic data to refine targeting efforts. Demographic and/or redemption data may optionally be provided to coupon issuers or retailers to modify or refine incentive offers based on consumer demand. Incentives may be stored electronically on the WAP user's computer and various management functions may be provided for the user to view, sort, store, print, delete, and/or redeem incentives.

A user may redeem incentives through electronic redemption, in-store redemption, or any combination thereof. For example, a user may send an electronic request to redeem an incentive over a network, and the electronic redemption request may be received by the proxy and forwarded to the server, which may facilitate an electronic sale. For example, a user may print the incentive to an available attached printer, and the printed incentive may be presented to a retailer for redemption. In another example, a combination of electronic and in-store redemption may allow the user to initiate redemption by submitting an electronic redemption request, and the proxy may receive the request and route the request to a retailer. The incentive data may be held by the retailer pending purchase by the user of the matching product, or the retailer may print out the incentive and scan the coupon as though the user had printed it. The retailer may identify the initiating user through a unique identifier included with the incentive data, a name or social security number included with the incentive data, or other identification means. After an incentive has been redeemed, deleted, or otherwise manipulated by the user, data may be sent to the server for updating demographic information, as well as optionally being forwarded to coupon issuers or retailers for adjusting offered incentives. In various implementations, the server may use redemption data to credit or reimburse various entities, such as the WAP provider in order to offset the cost of providing a hotspot, the coupon issuer, retailer, or any other relevant entity.

Other objects and advantages of the invention will be apparent to those skilled in the art based on the following detailed description and accompanying drawings.

### BRIEF DESCRIPTION OF THE DRAWINGS

FIG. 1 illustrates a schematic diagram of exemplary system architecture according to various aspects of the invention.

FIG. 2 illustrates a flowchart of an exemplary process for obtaining demographic information according to various aspects of the invention.

FIG. 3 illustrates a flowchart of an exemplary process for delivering targeted incentives to users based on a wireless access point according to various aspects of the invention.

FIG. 4 illustrates a flowchart of an exemplary process for redeeming incentives and refining the targeting process according to various aspects of the invention.

### DETAILED DESCRIPTION

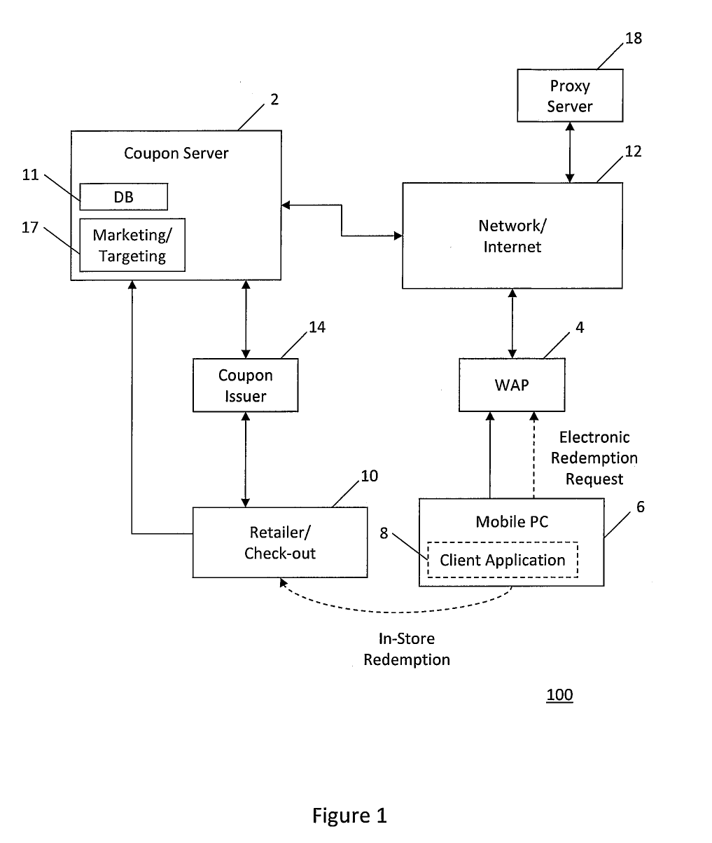

According to various aspects of the invention, as shown in FIG. 1, an exemplary system 100 for providing incentives to users based on a wireless access point (WAP) provides an integrated approach to marketing to users. For example, the system 100 may deliver incentives to users based on various criteria associated with a WAP, a particular user, or peer to peer affinities associated with the WAP or the user, among other criteria. The system 100 may include a repository of electronically stored incentive data, such as a coupon server 2 including a database 11, and a marketing/targeting module 17. Electronic incentive distribution system 100 may comprise one or more computer devices 6a-n, each of which may access a network 12 through any of a plurality of WAPs 4a-n. In various implementations, WAPs 4a-n may be located in, for example, airports, bookstores, hotels, coffee shops, or any other location in which wireless network access may be provided. In other implementations, a user may use a WAP within a personal or home network configuration.

In various implementations, a wireless Internet service provider may configure an associated WAP from among WAPs 4a-n to tunnel network traffic through a proxy 18. Proxy 18 facilitates the connection to coupon server 2 in order to deliver incentives to user devices 6a-n. In another implementation, a user may register with electronic incentive distribution system 100 and download a client application 8, and the client application 8 may establish the connection with proxy 18. Other implementations may enable a user to use a WAP to connect directly to coupon server 2, or other method of connecting to coupon server 2 may be used without departing from the scope of the invention.

Coupon server 2 may store in database 11 electronic incentive data provided by a retailer 10 or coupon issuer 14. The incentive data may be provided by electronic transmission via a PSTN, satellite data exchange, or any other transmission means. Coupon server 2 may also store demographic data within database 11 to be used by marketing/targeting module 17 to generate one or more incentives and/or customized incentives to user devices 6a-n. The demographic data may include user-specific data such as, without limitation, a user's age, gender, occupation, income class, product interests, purchasing habits, etc., as well as incentives that the user has previously selected, deleted, printed, and/or redeemed. The demographic data may also include WAP specific demographic data such as, without limitation, a geographical location associated with the WAP or the type of enterprise or operation providing WAP service. It will be apparent, however, that demographic data may include any suitable information that may be used by marketers to effectively target incentives to a user.

According to various aspects of the invention, demographic data stored in database 11 may be used by marketing/targeting module 17 to identify and deliver incentives to users based on a characteristic of the user and/or the WAP that the user may be connected to. For example, demographic data relating to specific users and demographic data relating to specific WAPs may be correlated by marketing/targeting module 17 to identify patterns of user activity and/or behavior at the WAP. Thus, coupon server 2, operating in conjunction with database 11 and marketing/targeting module 17, may utilize demographic data to compile incentive packages specifically targeted at users based on various criteria, including their location within a predetermined geographic area, proximity to a retail center, or likelihood of purchasing a product, without limitation. Moreover, when a user redeems an incentive, the demographic data may be updated to refine targeting efforts to make incentive packages more focused and effective. The demographic data, redemption data, or any combination or portion thereof may be provided to coupon issuer 14 or retailers 10, who may use the information to modify or refine incentive offers to better respond to consumer demand.

Coupon server 2 may store in database 11 data corresponding to the location of retailers, retail centers, or competitors of retailers or retail centers, each of which may be represented by reference numeral 10 in FIG. 1. A “competitor-retail center” may broadly include any place of business operated by a competitor of a retailer or other enterprise offering an incentive, or at which a user may purchase and/or receive a product other than a place of business operated by a retailer or other enterprise offering the incentive. “Products” may broadly denote goods, services, or any combination thereof, without limitation. The geographic location of a retail center or competitor-retail center may be represented by any identifier or set of identifiers, including local street address, city, township, county, state, country, zip-code, telephone area-code, telephone prefix, zone or region. Moreover, the location may be stored in database 11 using any suitable data format, such as metadata, coordinates, or customized data types, without limitation. The physical layout of the functions and components described in FIG. 1 represents a matter of practicality and choice of design, such that variation or modification of the components does not impact the utility of the invention.

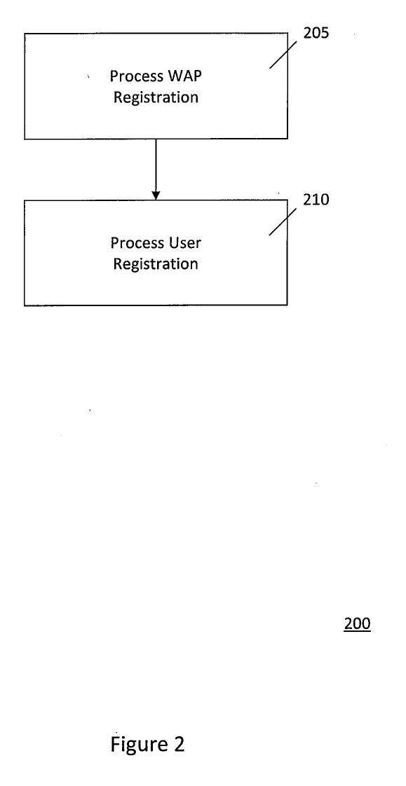

FIG. 2 illustrates an exemplary process 200 for obtaining demographic information according to various aspects of the invention. Process 200 may be performed at a system associated with an incentive service provider (e.g., an entity that operates coupon server 2 and/or proxy 18 as described in FIG. 1), which delivers customized incentives to users based on user demographic information and/or a wireless access point used by a user to connect to the incentive service provider.

Process 200 begins in an operation 205, where an owner or provider of a WAP may register with the incentive service provider. In various implementations, WAP registration operation 205 may comprise providing a registration form or application on a web site. In another implementation, the WAP provider may register by communicating with a customer service representative in a telephone call, mailing a registration form to the incentive service provider, or via any number of other techniques. Registering with incentive service provider may enable a WAP provider to provide differentiation with respect to competing entities by offering consumers additional services and features, such as the opportunity to save money on purchases in addition to accessing a network. In another implementation, the WAP provider may be able to reduce or eliminate the consumer costs of using the WAP. For example, when the WAP provider has been reimbursed or credited subsequent to a user redeeming an incentive provided via the WAP, the WAP provider may pass the savings on to consumers. It will be apparent, however, that these provide but several examples of possible business models that can be implemented using the techniques described herein, and that other business models or reasons for registering with the incentive service provider may be suitably substituted.

When a WAP provider registers in operation 205, the WAP provider may be prompted to create a unique identifier for the WAP, such as an IP address or a service set identifier (SSID). In another implementation, the incentive service provider may automatically generate the unique identifier. The incentive service provider may also request demographic information during WAP registration, such as a geographical location of the WAP (e.g., a city, state, or other location), a name of a WAP provider (e.g., Starbucks®), a type of operation of the WAP provider (e.g., coffee house), or other demographic information, without limitation. A database (e.g., database 11 of FIG. 1) may thus include entries associating a unique identifier for the WAP with demographic information associated with the WAP.

The invention may be practiced using any WAP arrangement, as will be apparent to those skilled in the art. For example, a WAP may be compatible with the IEEE 802.11 standard, and the WAP may connect to an attached local area network (LAN), wireless local area network (WLAN), or wide area network (WAN). In various implementations, a user may establish a home WLAN for personal connectivity to the Internet, or an enterprise may provide wireless Internet access for its customers, where network traffic passes through a WAP, as tends to be common in hotels, coffee shops, bookstores, etc. Further, various implementations may include one or more WAPs linked together to form a larger network enabling roaming between WAPs in a “lily-pad” arrangement, where users can move from one WAP to another while maintaining a continuous connection to the network, such as the approach taken by cities or municipalities providing Internet service for residents or visitors. Those skilled in the art will recognize that the invention may be practiced using many possible variations on WAP set-ups and/or providers.

In an operation 210, users may register with the incentive service provider. In various implementations, a user may register after connecting with a WAP that has registered with the incentive distribution service, as described in operation 205. The WAP may be configured to create a secure tunnel of network traffic through a proxy server (e.g., proxy server 18 of FIG. 1), for example, by modifying routing tables in the WAP to block all traffic except those configured in static routes. For instance, static routes may be provided to a proxy server to use as a gateway and to a domain name system (DNS) server to resolve Internet addresses. In another implementation, a user may independently register with the incentive service provider and download a client application that establishes the connection with the proxy server instead of, or in addition to, modifying the routing tables of a WAP. In other implementations, traffic may be tunneled through the proxy server by establishing a virtual private network (VPN) between the user and proxy server. It will be apparent that other techniques for creating a secure tunnel of network traffic may be used. Tunneling traffic, such as through the proxy server, allows various aspects of user activity to be monitored and analyzed for delivering more relevant, targeted incentives to users, while also facilitating redemption of incentives, as well as billing and/or reimbursement of the relevant entities upon completion of a transaction. In other implementations, a user may connect directly to a server that distributes incentives (e.g., coupon server 2 of FIG. 1), or other techniques of connecting to the service provider may be implemented.

Regardless of the method by which a user connects to a WAP, the incentive service provider may utilize the proxied connection to provide the user with a registration form or log-in screen in operation 210. In various implementations, the first time a user connects with electronic incentive distribution system 100, the user may be assigned a unique identifier, or the user may be prompted to select a unique identifier. The unique identifier may comprise a unique user identifier that identifies the user, or a device identifier that identifies a device which the user utilizes to access the system. If the user has previously accessed or registered with the incentive distribution system, the user may log-in by entering the unique identifier and a password, or a cookie may be stored on the user's computing device to bypass the log-in process. In another implementation, the user's unique identifier may be associated with a device rather than the user, such that the user can be easily identified, or a demographic profile built, when the device has been identified at the same or different WAPs over the course of time. Other techniques for processing user registration and logging in to a system will be apparent to those skilled in the art. Once a unique identifier has been created, it may be used to associate a user and/or device with demographic information describing the user and/or device, as discussed in greater detail below.

In various implementations, when a user registers, the user may be prompted to enter demographic information, including personal information, such as residence information (e.g., address, whether the user rents or owns), type of housing (e.g., townhouse, apartment, condominium, stand alone house, etc.), income, interests (or hobbies), marital status (e.g., single, married, divorced), household information (e.g., whether the user has children, how many, the age/gender of each child), ethnic background, pets, and other personal information, without limitation. In various implementations, the user may have the option of declining to provide demographic information or downloading an offline management program to enter the data later. When the user declines to enter demographic information, the system may attempt to derive demographic data by monitoring the user's browsing habits and activities, or the system may classify the user as a generic user and only target incentives based on information relating to the WAP. Other techniques for gathering or deriving demographic information will be apparent to those skilled in the art.

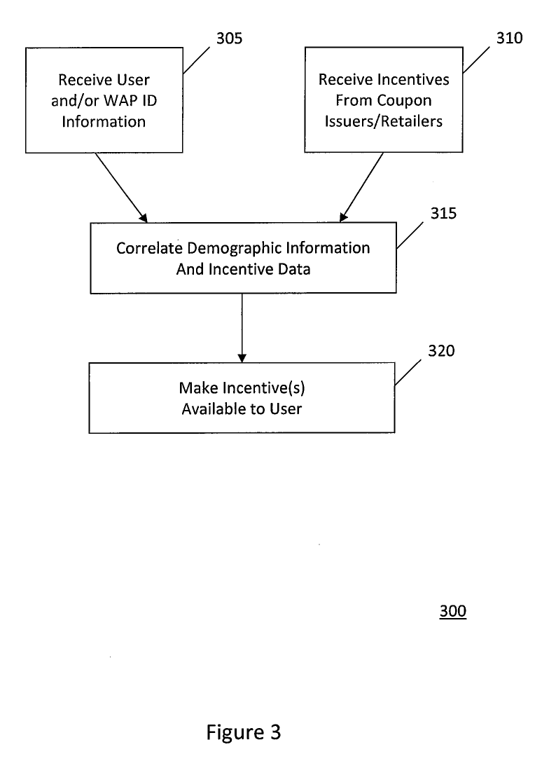

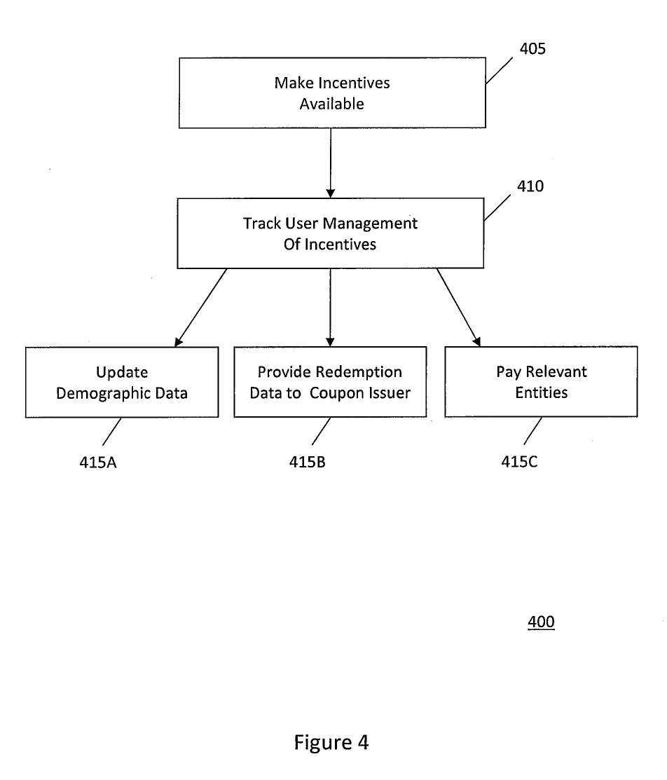

FIG. 3 illustrates an exemplary process 300 for delivering incentives targeted to users based on a wireless access point according to various aspects of the invention. In an operation 305, a server (e.g., coupon server 2 of FIG. 1) receives a WAP identifier that identifies a WAP to which the user has connected. The WAP identifier may comprise an IP address identified by a proxy when a user connects to the WAP, or other identification techniques may be used to identify the WAP, where such techniques will be apparent to those skilled in the art. When the user, device, and/or WAP identifier are received at operation 305, the server may lookup the identifiers in a database (e.g., database 11 of FIG. 1) to retrieve demographic information related to the user and/or WAP, respectively. This information may be analyzed in an operation 315, and used to deliver incentives to a user in an operation 320, as discussed in greater detail below. Moreover, the user and/or WAP demographic data received in operation 305 may be updated after an incentive has been redeemed to more accurately reflect user purchasing habits, as discussed in greater detail with reference to FIG. 4.

Still referring to FIG. 3, in an operation 310, the coupon server may receive and collect incentives and incentive data distributed by an issuing entity (e.g., retailer 10 or coupon issuer 14 of FIG. 1). The incentive data provided in operation 310 may include typical incentive data such as a redemption amount, company and product name, or expiration date, among other types of incentive data, as well as customized incentive data, such as proximity-based incentive data. Incentive data may be customized in various ways, including, for example, according to a user's proximity to an object or location associated with a product (e.g., a point-of-sale, a retail center, a store, a distribution center, a manufacturing facility, a factory outlet, an event site, etc.). Proximity-based customization may specify, for example, that an incentive may be delivered to a user when the user falls within a certain radius of a point-of-sale, or the incentive may have a first redemption amount for users in a first predetermined geographic area and a second redemption amount for users in a second predetermined geographic area, without limitation. Providers of incentives may similarly customize incentives for a particular clientele (e.g., special promotions for first-time customers), according to a purchase characteristic (e.g., larger discounts on larger purchases), or in any other suitable way that a coupon issuer, retailer, or marketer desires to reach consumers. Moreover, when a user redeems an incentive, the redemption information may be provided back to the issuing entity to give incentive providers a way to more accurately gauge user purchasing habits and create more focused and effective incentives, as discussed in greater detail below.

Once the server has received the unique identifier and wireless access point identifier at operation 305, and the incentives and incentive data at operation 310, demographic data associated with the user and WAP may be correlated with the incentive data (as well as redemption data obtained through the process of FIG. 4) in an operation 315. The results of correlation operation 315 may then used in making incentives available to the user in an operation 320. Correlation operation 315 may be performed by marketing/targeting module 17 of FIG. 1 to generate a WAP demographic profile by identifying characteristics of users that connect to a particular WAP. Further, in various implementations, patterns of user activity and/or behavior when connected to the WAP may be used in correlation operation 315.

Many different correlation and analysis algorithms may be employed to generate an incentive or incentive package for a user. For example, users of a WAP provided by a particular enterprise may share brand loyalty (e.g., Barnes and Noble® users may be particularly interested in Barnes and Noble® incentives), while users of a WAP provided by a particular type of enterprise may share common interests (e.g., hotel users may be particularly interested in travel incentives). In another example, operation 315 may determine that users with dogs in their household, which may be known from demographic responses, will get a certain package comprising dog food incentives. It may further be determined that users within a certain proximity of a pet supply store will receive dog food incentives eligible for redemption at the pet supply store. It may further be determined that users who redeem dog food incentives of Brand X will get incentives issued by Brand Y, or will get only low value incentives because they are already dog food incentive users, etc. That is, depending on the marketing and targeting criteria and objectives, correlation operation 315 may identify incentives as desired or a promotion may be customized based on a combination of proximity ranges, competitor parameters, and marketing and targeting criteria and objectives.

In various implementations, operation 315 may generate a customized incentive package according to marketing analysis relating to user location data and redemption data for users within specified locations and specified proximity ranges to retail centers and competitor-retail centers, as well as other external data (e.g., data relating to non-incentive transactions, inventory turnover, market conditions, cost of raw materials, etc.). The marketing analysis based on user location data and redemption data for users within a specific location/proximity range may be derived from correlating user demographics with an associated wireless access point. As an illustrative example, redemption data may indicate a 60% redemption rate for users located within a 1 to 2 mile radius of a retail center and a 5% redemption rate for users located within a 2.1 to 3 mile radius of the retail center. In response to received redemption data, the incentive packages may be adjusted by the coupon issuer to increase the incentive offered to the users in the 2.1 to 3 mile radius.

Further, in various implementations, certain demographic information may be ignored when compiling incentive packages (e.g., an incentive may be delivered to all users of a particular WAP), or certain demographic data may be given more importance than others (e.g., a large chain store values demographics that indicate a user may be a likely customer more than a user's location). Moreover, the degree of an incentive given to a user may be modified depending on certain demographic information about the user. For example, a larger discount may be given to customers of a competitor brand than for known users of a brand, where brand preferences may be learned through the redemption process described in FIG. 4. The correlation operation 315 may thus use many different algorithms to generate incentive packages for a user, without limitation, depending on a marketing objective and/or strategy deemed most likely to succeed, return the largest profit, etc.

Once an incentive package has been created for a WAP user in operation 315, an operation 320 makes the incentives available to the user. The incentive data may be formatted into a secure data format to preclude the possibility of fraud by consumers as well as retailers. Thus, the incentive data may be made available to users by any technique of securing data on a network, such as securing a connection by routing traffic through a proxy, as described above. In various implementations, the incentives may be made available to the user by pushing the incentive down to the user, such as by sending a secure data file to the user. In another implementation, incentives may be made available by providing the user with a link or other visual notification that incentives are available to download. Other techniques for providing incentives or notifying users of the availability of incentives may be used without departing from the scope of the invention, including e-mail notification, auditory stimulus, or other methods.

FIG. 4 illustrates an exemplary process 400 for redeeming incentives and refining the targeting process according to various aspects of the invention. In an operation 405, incentives and incentive data may be made available to an end user. Making incentives available to end users may include techniques as described above in operation 320 of FIG. 3. For example, an online display may be provided to a user when the user connects to the electronic incentive distribution service. The online display may present the user with an interface for initiating a download of an incentive file containing the secure incentive data, or the incentive data may be automatically pushed down to a user device. In various implementations, a user may be provided with a visual or auditory stimulus or cue suggesting an access of the electronic incentive distribution system. For example, a banner, pop-up, or other notification may be provided to a WAP user to indicate that an incentive may be available for the user to redeem. Other notification methods will be apparent to those skilled in the art.

When a user downloads an incentive, the incentive data may be securely provided to the user by the proxy server. The incentive may further be secured using a secure data format to encode the incentive. For example, each incentive may be given a unique bar code for a user, such that when a coupon has been scanned after being presented for redemption in an operation 410, the redemption information may be forwarded to a server (e.g., coupon server 2 of FIG. 1) in an operation 415a. Thus, the server may know if an incentive has been redeemed and further redemption of a photocopied incentive bearing the same indicia may be disallowed. Moreover, the incentive may be encoded such that the incentive can only be printed once, or printing the incentive may be limited to a predetermined number of times (e.g., two or more times).

In instances where WAP users do not have access to a printer, the incentive may be stored electronically on the WAP user's computer and various incentive management functions may be provided for the user to store, manipulate, and redeem the incentives. The user's behavior in managing the incentives may be tracked in an operation 410. The management functions may equally be available to users who do or do not have access to a printer. Information relating to incentive management in operation 410 may be used to update user and/or WAP demographic data in operation 415a. Incentive management information from operation 410 may also be forwarded to retailers and coupon issuers for refining marketing strategies in an operation 415b. Moreover, when a user redeems an incentive, the electronic incentive distribution system may track the information in operation 410 and use the redemption data in an operation 415c to credit or reimburse a WAP provider, coupon issuer, a retailer, a product supplier, or any other relevant entity in accordance with similar techniques of coupon reimbursement that will be apparent to those skilled in the art.

In various implementations, the management functions tracked in operation 410 include a user viewing, sorting, storing, printing, deleting, and/or redeeming incentives, as well as managing shopping lists associated with incentives. In various implementations, a user connects to the electronic incentive distribution service (e.g., through a proxy as described in FIG. 2, or using other techniques), and the user's management of incentives may be tracked in operation 410 and relayed to a server in operation 415a. The management data may optionally provided to coupon issuers and/or retailers in operation 415b. The activities tracked in operation 410 may be used to build more accurate profiles of users and WAPs in order to refine the process by which incentive packages are generated.

The redemption functions provide various methods for a wireless access point user to redeem an incentive. In various implementations, a WAP user with access to an attached printer may print an incentive for in-store redemption. The incentive may be encoded with printable incentive data, including various incentive data such as an expiration date, redemption amount, company/product information, UPC code, redemption address, or a description of the incentive offer, as well as information uniquely identifying the user, such as a unique user identifier, name, or social security number of the user. Thus, after the incentive has been presented for in-store redemption and scanned by a retailer, the electronic distribution service automatically updates stored demographic information in operation 415a. The updated demographic information may include the user that redeemed the coupon, the WAP the user was connected to when the incentive was delivered, the product purchased with the redeemed coupon, etc. This information may optionally be forwarded to coupon issuers in operation 415b, who may adjust incentives based on the data. The server may use the redemption data in operation 415c to credit or reimburse the necessary entities. Any reimbursement or crediting technique known to those skilled in the art may be used without departing from the inventive concepts disclosed herein.

When a WAP user does not have access to an attached printer, various implementations may address such situations where users nonetheless desire to redeem the incentive. In such cases, user management functions may include various methods for electronic redemption of the incentives. For example, the management functions may enable the user to send a request to initiate a transaction including redemption of the incentive over a network. The request may be received by the proxy and forwarded to the server, or the request may be received directly by the server. The server may then facilitate an electronic sale in an “electronic shopping mall” environment commonly provided by online merchants. In another implementation, the user may desire to initiate in-store redemption of an incentive, which may be particularly useful for mobile users in a geographic proximity to a brick-and-mortar retailer, increasing the likelihood of an “impulse buy.” Such redemption may be enabled by a user submitting a redemption request to the network, where a proxy may receive the request and route the request to retailer store where the user will shop. The incentive data may be held by the retailer pending purchase by the user of the matching product, or alternatively, the retailer may print out the incentive and scan the coupon as though the user had printed it. The incentive data received by the retailer may include data describing the redeeming user, such that the retailer may verify the identity of the user when the user arrives in the store to redeem the incentive.

Thus, after a user has taken action in managing an incentive, whether by saving, deleting, redeeming, or taking some other action, the server may receive incentive redemption data or other feedback regarding the incentives in an operation 415a. The server may verify the value of the redeemed coupons, determine the identity of users who have redeemed the incentive, and/or determine the identity of the WAPs where the incentives were distributed. The server may collate the information regarding the redeemed incentive for use in compiling subsequent incentive packages targeted specifically at certain users, WAPs, or the like. The information may be distributed to the entity that issued the coupon in operation 415b, wherein the coupon issuer may credit the redeeming retail center with the total amount of discounts given in operation 415c.

Implementations of the invention may be made in hardware, firmware, software, or any suitable combination thereof. The invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable storage medium may include read only memory, random access memory, magnetic disk storage media, optical storage media, flash memory devices, and others, and a machine-readable transmission media may include forms of propagated signals, such as carrier waves, infrared signals, digital signals, and others. Further, firmware, software, routines, or instructions may be described in the above disclosure in terms of specific exemplary aspects and implementations of the invention, and performing certain actions. However, it will be apparent that such descriptions are merely for convenience and that such actions in fact result from computing devices, processors, controllers, or other devices executing the firmware, software, routines, or instructions.

Aspects and implementations may be described as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other aspects or implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

What is claimed is:

1. A method for providing incentives to consumers, the method comprising:
receiving a plurality of incentives, each incentive having incentive data;
establishing a connection with at least one user of a wireless access point (WAP);
generating at least one incentive for the at least one user, wherein the at least one incentive is generated based on a correlation of at least one of a profile of the WAP, a profile of the user, or the incentive data; and
making the at least one incentive available to the user.

2. The method of claim 1, wherein the plurality of incentives include at least one of a web page, a promotion, a banner, an offering, a gift, a raffle ticket, a contest ticket, a product price, or a product discount.

3. The method of claim 1, wherein the user profile includes data representing at least one of demographic data associated with the user or behavior patterns of the user.

4. The method of claim 3, wherein the WAP profile includes data representing at least one of a geographic location of the WAP, a type of operation of an entity providing the WAP, or a profile of users of the WAP.

5. The method of claim 4, wherein the incentive data includes data representing at least one of a product, a product category, a redemption amount, a redemption discount, a time, a date, an expiration date, a point-of-sale, a predetermined proximity range from the point-of-sale, or a predetermined geographic area.

6. The method of claim 5, wherein the at least one incentive is generated when the geographic location of the WAP is within at least one of the predetermined proximity range or the predetermined geographic area included in the incentive data of the at least one incentive.

7. The method of claim 1, further comprising:
customizing the generated incentive based on at least one of the WAP profile, the user profile, and the incentive data; and
making the customized incentive available to the user.

8. The method of claim 1, further comprising processing a redemption of the at least one incentive.

9. The method of claim 8, further comprising modifying at least one of the WAP profile, the user profile, or the redeemed incentive in response to the redemption.

10. A computer-readable medium containing computer-executable instructions for providing incentives to consumers, the computer-executable instructions collectively configured to:
receive a plurality of incentives, each incentive having incentive data;
establish a connection with at least one user of a wireless access point (WAP);
generate at least one incentive for the at least one user, wherein the at least one incentive is generated based on a correlation of at least one of a profile of the WAP, a profile of the user, or the incentive data; and
make the at least one incentive available to the user.

11. The computer-readable medium of claim 10, wherein the plurality of incentives include at least one of a web page, a promotion, a banner, an offering, a gift, a raffle ticket, a contest ticket, a product price, or a product discount.

12. The computer-readable medium of claim 10, wherein the user profile includes data representing at least one of demographic data associated with the user or behavior patterns of the user.

13. The computer-readable medium of claim 12, wherein the WAP profile includes data representing at least one of a geographic location of the WAP, a type of operation of an entity providing the WAP, or a profile of users of the WAP.

14. The computer-readable medium of claim 13, wherein the incentive data includes data representing at least one of a product, a product category, a redemption amount, a redemption discount, a time, a date, an expiration date, a point-of-sale, a predetermined proximity range from the point-of-sale, or a predetermined geographic area.

15. The computer-readable medium of claim 14, wherein the at least one incentive is generated when the geographic location of the WAP is within at least one of the predetermined proximity range or the predetermined geographic area included in the incentive data of the at least one incentive.

16. The computer-readable medium of claim 10, the computer-executable instructions further configured to:
customize the generated incentive based on at least one of the WAP profile, the user profile, and the incentive data; and
make the customized incentive available to the user.

17. The computer-readable medium of claim 10, the computer-executable instructions further configured to process a redemption of the at least one incentive.

18. The computer-readable medium of claim 17, the computer-executable instructions further configured to modify at least one of the WAP profile, the user profile, or the redeemed incentive in response to the redemption.

19. A system for providing incentives to consumers, the system comprising one or more processing devices collectively configured to:
receive a plurality of incentives, each incentive having incentive data;
establish a connection with at least one user of a wireless access point (WAP);
generate at least one incentive for the at least one user, wherein the at least one incentive is generated based on a correlation of at least one of a profile of the WAP, a profile of the user, or the incentive data; and
make the at least one incentive available to the user.

20. The system of claim 19, wherein the plurality of incentives include at least one of a web page, a promotion, a banner, an offering, a gift, a raffle ticket, a contest ticket, a product price, or a product discount.

21. The system of claim 19, wherein the user profile includes data representing at least one of demographic data associated with the user or behavior patterns of the user.

22. The system of claim 21, wherein the WAP profile includes data representing at least one of a geographic location of the WAP, a type of operation of an entity providing the WAP, or a profile of users of the WAP.

23. The system of claim 22, wherein the incentive data includes data representing at least one of a product, a product category, a redemption amount, a redemption discount, a time, a date, an expiration date, a point-of-sale, a predetermined proximity range from the point-of-sale, or a predetermined geographic area.

24. The system of claim 23, wherein the at least one incentive is generated when the geographic location of the WAP is within at least one of the predetermined proximity range or the predetermined geographic area included in the incentive data of the at least one incentive.

25. The system of claim 19, the one or more processing devices further configured to:
customize the generated incentive based on at least one of the WAP profile, the user profile, and the incentive data; and
make the customized incentive available to the user.

26. The system of claim 19, the one or more processing devices further configured to process a redemption of the at least one incentive.

27. The system of claim 26, the one or more processing devices further configured to modify at least one of the WAP profile, the user profile, or the redeemed incentive in response to the redemption.
